(19) United States
(12) Patent Application Publication
(10) Pub. No.: US 2005/0123167 A1
(43) Pub. Date: Jun. 9, 2005

(54) Method and system for watermarking an electronically depicted image

(76) Inventors: Kurato Maeno, Warabi-shi (JP); Oibin Sun, Singapore (SG); Shih-fu Chang, New York, NY (US); Masayuki Suto, New York, NY (US)

Correspondence Address: RABIN & Berdo, PC, 1101 14TH STREET, NW, SUITE 500, WASHINGTON, DC, 20005, US

(21) Appl. No.: 10/482,074

(22) PCT Filed: Jun. 28, 2002
(86) PCT No.: PCT/US02/16600

(30) Foreign Application Priority Data
Jun. 29, 2001 (US) 60302188

(51) Int. Cl. G06K 9/00; G06K 9/36

(52) U.S. Cl. 382/100; 382/232

(57) ABSTRACT

A system for watermarking an image file selects coefficients using a selection procedure that is kept secret, and assigns the selected coefficients to coefficient pairs. The difference between the coefficients of the pairs is then used to generate multi-bit raw signature values that characterize the authentic image at different locations. To detect an unauthorized alteration after the image file has been watermarked, coefficient pairs are selected using the same secret procedure that was originally used to generate the raw signature values. The difference between the coefficients of the pairs is then checked against the raw signature values derived from the original image file. The raw signature values derived from the authentic image file may be placed in the header of the file or in a separate file. Alternatively, they may be embedded in host coefficients that are selected in accordance with a procedure that is kept secret. To reduce the risk of false alarms, more than one raw signature value may be accepted for certain difference ranges of the difference between coefficients of the pairs. Furthermore, the raw signature values may be grouped into sets, which are mapped onto shortened signature codes having a reduced number of bits. The assignment of sets of raw signature values to the shortened signature codes may be based on the probability of the sets of raw signature values.

### BACKGROUND OF THE INVENTION

The present invention is directed to a method and a system for watermarking an electronically depicted image so that unauthorized alterations in the image can be detected.

A colored photograph of a scene such as a bowl of fruit typically contains many variations in color and shading. The apple may be predominantly red but have regions of a brownish or yellowish hue, and perhaps areas that are still green to one degree or another. The bananas are various shades of yellow and brown, with perhaps some green, too, and the grapes are purple. Shadows and highlights suggest the curvature of the fruit. Despite this visual complexity, though, every spot on the photograph can be depicted by a point in a color space defined by a red axis, a green axis that is orthogonal to the red axis, and a blue axis that is orthogonal to both the red and green axes. At the origin of this RGB coordinate system, where all three colors have the value of zero, the visual impression is black. At some maximum value along the red axis, green axis, and blue axis, the visual impression is white. Between black at the origin and white at some common, maximum value along all three axes, a line can be drawn that depicts various shades of gray.

This line that depicts various shades of gray can be used to establish an axis in a new color space. This axis is called the luminance axis (generally designated by the letter Y), and it is accompanied in the new color space by a red chrominance axis (commonly designated Cr or V) and a blue chrominance axis (commonly represented by Cb or U). Just as every spot on the photograph could be represented in the RGB color space, every spot can be represented in the YCrCb color space. Simple equations for translating from the RGB color space to the YCrCb are well known. Other color spaces are also known and used on occasion.

The human eye is much more sensitive to changes in the gray level than it is to changes in color. This means that the luminance information is more important than the chrominance information or, in other words, the apparent quality of an image falls only slowly as chrominance information is discarded. Various image encoding techniques (which also typically permit data compression) exploit this fact in order to reduce the file size of an image without a commensurate loss in the apparent quality of the image.

One such encoding technique is the original JPEG technique, introduced by the Joint Photographic Experts Group in the early 1990s. It is described in the standard ISO/IEC 10918-1. The original JPEG technique (occasionally called “JPEG-original” hereafter) will now be summarized with reference to FIGS. 1A and 1B.

In FIG. 1A, an image encoder 20 receives an input signal from an image source unit 22, such as a digital camera, a scanner, or a memory that stores the image. It will be assumed that the input signal is a digital signal with red, green, and blue components. The encoder 20 includes a color space converter 24 that converts the red, green, and blue components of the input signal to a YCrCb color space. The luminance (or Y) component is fed to a luminance branch 26. The red chrominance (or Cr) component is fed to a red chrominance branch 28, and the blue chrominance (or Cb) component is fed to a blue chrominance branch 30. The branch 26 for the luminance component includes a subdivision unit 32, a discrete cosine transform (DCT) unit 34, a quantizer 36, and an entropy encoder 38 (a Huffman encoder, which reduces the file size by assigning codes to data words, with the shorter codes being assigned to the data words that are more likely to be present and with longer codes being assigned to less likely data words).

The subdivision unit 32 divides the luminance component into blocks that are 8 pixels wide and 8 pixels high. The DCT unit 34 performs a discrete cosine transform or DCT on each of these blocks. The discrete cosine transform, which is related to the Fourier transform, results in sixty four coefficients for weighting sixty four basis functions, or basis images. The sixty four basis functions employed in the discrete cosine transform essentially represent patterns that are coextensive with the original block and that depict the frequency of changes in the horizontal direction of the block and in the vertical direction of the block. Here, “frequency” refers to the rate of variations with respect to space, not time. The portion of the original image that is represented by the 64 pixel values in the 8×8 block is equivalent to the sum of the sixty four basis functions, weighted by the coefficients generated via the discrete cosine transform.

The sixty four coefficients that are generated by DCT unit 34 for each block are placed in array, in a predetermined order, and provided to the quantizer 36. It is the quantizer 36 (and the quantizations in the chrominance branches) that is the primary engine for data compression. The quantizer 36 employs a quantization table having sixty four quantization values, one for each of the sixty four DCT coefficients. Different quantizing tables may be selected depending upon the desired quality of the compressed image. The higher the quality, the less the compression. The quantizing values in the selected table are integers (some of which are typically the same). The quantizer 36 quantizes the DCT coefficients by dividing each coefficient by its corresponding quantizing value and then rounding down to the nearest integer, discarding any fractional results. Since the DCT coefficients for basis functions with higher frequency variations tend to be small, in practice, and also since the quantizing values for these coefficients are larger in magnitude than the quantizing values for coefficients corresponding to lower frequency basis functions, the DCT coefficients for the higher frequency basis functions are frequency quantized to 0. The elimination of fractional results during the quantization process and the likelihood that a substantial number of the quantized coefficients will turnout to be 0, in practice, means that substantial data compression is achieved by the quantizer 36. Further data compression is achieved by the encoder 38, which entropy encodes the quantized DCT coefficients and supplies them to a formatting unit 40.

The branches 28 and 30 for the chrominance components are the same, in general, as the branch 26 described above for the luminance component. The primary difference is in the quantizers. Since the human eye is less sensitive to spatial variations in color than it is to spatial variations in luminance, the quantizing tables used by the quantizers in branches 28 and 30 have quantizing values that are larger in magnitude than the quantizing values in the table employed in quantizer 36. The result is that the amount of data discarded in the chrominance branches is larger than the amount discarded in the luminance branch, without this increased loss of data degrading the apparent quality of the compressed image significantly. The quantized-and-encoded DCT coefficients in the chrominance branches, like the quantized-and-encoded DCT coefficients in the luminance branch, are supplied to the formatting unit 40.

The formatting unit 40 assembles the quantized-and-encoded coefficients into an encoded image data frame. It provides the frame with a header having various information, including information about the quantization tables employed and the encoding by the encoders 38, so that the encoded image can be reconstructed. The frame is then delivered to a utilization unit 42, such as a storage device, an interface to a transmission medium which conveys the frame to another location, or a decoder to reconstruct the image for immediate presentation on a display.

An image decoder 44 for reconstructing the image is shown in FIG. 1B. It receives the encoded image data frame from an encoded image source 46, and includes a payload extractor 48 which delivers the quantized-and-encoded coefficients for luminance to a luminance branch 50, the quantized-and-encoded coefficients for red chrominance to a red chrominance branch 52, and the quantized-and-encoded coefficients for blue chrominance to a blue chrominance branch 54. The payload extractor 48 also retrieves information about quantization and encoding from the header of the frame and supplies this information to the branches 50-54. Each of these branches basically performs operations that are the inverse of the operations performed by the corresponding branches of the image encoder 20 in FIG. 1A. For example, the luminance branch 50 includes a decoder 56 that expands the data encoded by encoder 38. The expanded data is provided to an inverse quantizer 58, which multiplies the quantized coefficients by the same quantization value by which they were divided in the quantizer 36. The results are provided to an inverse transform unit 60, which performs an inverse discrete cosine transform in order to regenerate 8×8 blocks of pixel values that approximate the original 8×8 blocks. Such blocks are assembled into a total luminance image by a subdivision assembly unit 62. The total luminance image, together with total chrominance images from the branches 52 and 54, are then supplied to a color space converter 64, which transforms the image back to RGB space. The reconstructed image can then be shown on a display device 66.

Photo editing software is available which permits image files to be manipulated in a wide variety of ways. An image may be cropped, for example, or altered by replacing a portion of the image with content taken from a different image. Other editing possibilities include increasing the compression, adjusting the colors, copying one portion of an image over a second portion in order to obliterate the second portion, and so forth. Such alterations may have a benign purpose, as when a blemish is removed from a portrait, or they may have a malicious purpose, as when the picture of an automobile accident is altered in an attempt to avoid responsibility by deception. Regardless of the purpose, alteration of an image can be characterized as an attack on the integrity of the image. It is desirable to be able to detect such an attack. An image is said to be watermarked if means are provided for detecting an attack, other than perhaps an acceptable degree of compression (which carries with it corresponding reduction in image quality), or adjustment of brightness or colors.

The springboard for the present invention is a watermarking technique described by Ching-Yung Lin and Shih-Fu Chang (who is one of the co-inventors herein) in an article entitled “Semi-Fragile Watermarking for Authenticating JPEG Visual Content,” Proc. SPIE, Security and Watermarking of Multimedia Contents, San Jose, Calif., pp. 140-151, January 2000. Here, “semi-fragile” means that the watermarking technique is sufficiently flexible to accommodate acceptable manipulation of the image, such as a modest degree of compression, but has a low tolerance for other other types of image manipulation.

In the watermarking technique described in the above-noted article by Lin and Chang, so-called “signature” bits are generated from an image and then embedded in the image. To generate the signature bits, 8×8 blocks of an image are grouped in pairs of blocks using a secret mapping function. For each block pair, predetermined DCT coefficients are selected. The signature bits are generated on the basis of the relationship between the magnitude of the selected coefficients for one block of a pair and the magnitude of the selected coefficients for the other block of the pair. More specifically, if a given coefficient for the first block of a pair is smaller than the given coefficient for the second block of the pair, a signature bit of 0 is generated; and otherwise, a signature bit of 1 is generated. This can be expressed as:
Sᵢ=1 if Fᵢ (block 1)−Fᵢ (block 2)≧0,
and
Sᵢ=0 if Fᵢ (block 1)−Fᵢ (block 2)<0 Equations (1)
Here, Sᵢ is the i-th signature bit, which characterizes the relationship between the i-th DCT coefficients Fᵢ generated from block 1 and block 2 of a two-block pair.

The signature bits Sᵢ are embedded by using a secret mapping function to select coefficients arising from the block pair to serve as hosts for the embedding. The embedding is accomplished by adjusting the least significant bits of the host coefficients in accordance with the signature bits.

This procedure for generating signature bits and selecting host coefficients in which they will be embedded will now be illustrated by an example, with reference to FIGS. 2A-2C. FIG. 2A shows an image 68 of a house and the sun in the sky above it. Using a first secret mapping function, 8-pixel by 8-pixel blocks 70, 72, and 74 are selected and are paired with 8-pixel by 8-pixel blocks 76, 78, and 80. FIG. 2B illustrates an array 70′ for receiving the sixty four DCT coefficients generated from, say, the luminance component of block 70. Summarily, FIG. 2C illustrates an array 76′ for receiving the sixty-four DCT coefficients generated from the luminance component of block 76, which is paired with block 70. Using further mapping rules, signature-source coefficients in the arrays 70′ and 76′ that are to be used for generating signature bits are selected, and host coefficients where the signature bits are to be embedded are selected as well. This is illustrated, in this example, by using circles in FIGS. 2B and 2C to designate source coefficients selected for generating signature bits. Hexagons are used to designate host coefficients selected for embedding the signature bits.

For purposes of illustration, suppose that the first signature bit S₁ for the block pair 70, 76 is to be generated from the coefficient at row number 1, column number 1 of array 70′ and the corresponding coefficient at row number 1, column number 1 of array 76′, and that this signature bit is to be embedded in the coefficient at row 6, column 5 of array 70′. Applying Equations 1, the signature bit to be embedded would be S1=1 if the coefficient at row 1 column 1 in array 70′ is as large or larger than the coefficient at row 1, column 1 of array 76′, and S1=0 if the coefficient at row 1, column 1 of array 70′ is smaller than the coefficient at column 1, row 1 of array 76′.

The embedding operation described in the above-noted article by Lin and Chang is conducted by replacing the DCT coefficient F_{6,5} that would normally appear at row 6, column 5 of array 70′ (that is, the host coefficient in this example) by a modified value F*_{6,5}, called a reference coefficient. It is calculated a two-step procedure from F_{6,5}, the signature bit Sᵢ (where i=1 in this example), and the quantization value Q_{6,5} by which F_{6,5} would normally be divided during the subsequent quantization procedure. In the first step, F_{6,5} and Q_{6,5} are used to calculate an intermediate value, as follows:

$${f}_{6 , 5} = IntegerRound \frac{{F}_{6 , 5}}{{Q}_{6 , 5} + 1} \qquad Equation ( 2 )$$

Here, “IntegerRound” means rounded up or down to the nearest integer. In the second step, the reference coefficient F*_{6,5} is calculated as follows:

$${F}_{6 , 5}^{*} = {f}_{6 , 5} ( {Q}_{6 , 5} + 1 ) if the LSB of {f}_{6 , 5} = {S}_{i} , \\ and \\ {F}_{6 , 5}^{*} = [ {f}_{6 , 5} + sgn ( \frac{{F}_{6 , 5}}{{Q}_{6 , 5} + 1} - {f}_{6 , 5} ) ] ( {Q}_{6 , 5} + 1 ) \\ if the LSB of {f}_{6 , 5} \neq {S}_{i} \qquad Equations ( 3 )$$

Here, “sgn” is minus 1 if the expression following it is negative and plus 1 if the expression following it is not negative.

In the authentication process, signature bits are extracted from the received image and check to see whether they meet criteria set forth in the article by Lin and Chang. The article introduces two theorems, one of which basically provides that there is an invariant relationship, before and after quantization, between DCT coefficients generated from two 8×8 non-overlapping blocks of an image. The second theorem basically provides that, under certain conditions, the exact value of an unquantized coefficient can be reconstructed after quantization. In particular, the second theorem asserts that if a DCT coefficient is modified to an integral multiple of a pre-determined quantization value which is larger than all possible quantization values in subsequent JPEG compression, then this modified coefficient can be exactly reconstructed following JPEG compression by use of the same quantization value that was employed in the original modification. This theorem provides the rationale for using the reference coefficients F*. From equations 3, it will be apparent that embedding the signature bits as described in the above-noted article by Lin and Chang results in, at worst, a rather small modification in the quantized values. The procedure permits areas where an image has been attacked to be identified, in many cases.

The Lin and Chang article noted above addresses the possibility of false alarms, and mentions the possibility of using a tolerance bound. Such false alarms may arise due to noise, particularly if the noise is accompanied by acceptable modifications such as editing to adjust brightness. The possibility of a false alarm rises to significant levels if the i-th coefficients for the blocks of a pair have close numerical values when Equations (1) are applied, since in this case the signature bit Sᵢ is determined on the basis of a small positive or negative number. A tolerance bound M can be established, during the signature-checking stage, for withholding judgment about whether an attack has been made if the absolute value of the difference between the coefficients is smaller than M, as follows:

TABLE 1

| Relationship Range | Signature Sᵢ |
|---|---|
| Fᵢ(block 1)-Fᵢ(block 2) > M | Only Sᵢ = 0 is acceptable. |
| \| Fᵢ(block 1)-Fᵢ(block 2) \| ≦ M | Don't care. |
| Fᵢ(block 1)-Fᵢ(block 2) < − M | Only Sᵢ = 1 is acceptable |

This can be illustrated with the aid of FIG. 2D. The horizontal axis represents the difference between the i-th coefficient of the two blocks of a pair when an image is encoded (that is, on the signature-generation side), and the vertical axis represents the difference as determined when the encoded image is decoded (that is, on the signature-verification side). A signature bit having a value Sᵢ=0 is generated on the signature-generation side when the difference is greater than or equal to 0 (see Equations 2), or to the right side of the vertical axis. Without the tolerance bound M, one would expect the difference between the coefficients at the verification site to be 0 or greater in the absence of an attack. What the tolerance bound M does is to provide an indeterminate band of width 2M that follows the horizontal axis in FIG. 2D.

While the tolerance bound M reduces false alarms, it also provides a “safe harbor” for attacking an image. The reason is that an attack cannot be detected if the absolute value of the difference between the quantized coefficients is less than M. If attacks which meet this constraint were impossible or even very difficult, this vulnerability could be overlooked. Unfortunately, attacks such as replacing an object from one image with an object from another image, copying a portion of the background in an image over an object to hide the object, deleting text from a white background, inserting an object, or drawing an object on a light background may well result in quantized coefficients whose difference is small.

Image encoding techniques employing discrete cosine transforms together with compression have proven themselves to be very useful, as evidenced by the widespread success of JPEG-original. Nevertheless, image encoding using other basic approaches continues to attract attention. One of these alternative approaches employs wavelet transforms to generate coefficients, instead of discrete cosine transforms. This approach has been selected for use in JPEG-2000. The specifications for JPEG-2000 have been published as ISO/IEC JTC 1/SC 29/WG1.

Like the discrete cosine transform, a wavelet transform is related to the well-known Fourier transform. Unlike a discrete cosine transform, however, a discrete wavelet transform analyzes an input signal with reference to compact functions that have a value of zero outside a limited range. Cosine terms, in contrast, have recurring, non-zero values outside a limited range. In the image encoding field, discrete wavelet transforms typically employ a family of orthogonal wavelets generated by translating a so-called “mother wavelet” to different positions and by dilating (or expanding) the mother wavelet by factors of two. Various mother wavelets that can be used to generate families of orthogonal or almost-orthogonal wavelets for use in a DWT are known. Using a DWT to analyze an input signal generates coefficients which, basically, provide an index of how well the input signal correlates with the wavelets. The coefficients provide frequency information about the input signal (in view of the dilations) as well as position information (in view of the translations).

FIG. 3A illustrates an image encoder 80 which receives an RGB image from an image source unit 82. The encoder 80 includes a color space converter 84 which converts the image to a luminance (Y) component that is supplied to a luminance branch 86, a red chrominance (Cr) component that is supplied to a red chrominance branch 88, and a blue chrominance (Cb) component that is supplied to a blue chrominance branch 90. The luminance branch 86 includes a subdivision unit 92 that separates the luminance component into sub-units known as tiles, which are supplied to a discrete wavelet transform unit 94. The DWT unit 94 generates wavelet coefficients by using digital filters, which have characteristics that are based on the wavelet family employed.

FIG. 3B schematically illustrates a conceptual implementation of the DWT unit 94. The input signal from unit 92, representing a tile of the luminance component, is supplied to a high pass filter 96, which filters in the row direction and which is followed by a down-sampler 98, which down-samples the filtered signal by two (meaning that every other sample is discarded). The filtered and down-sampled signal is then supplied to a high pass filter 100, which filters in the column direction. The result is down-sampled by two by a down-sampler 102. The result is a set of the DWT coefficients in a so-called 1HH band (“1” indicating the first level of decomposition and “HH” meaning high pass filtration in both the row and column direction). The output of down-sampler 98 is also supplied to a low pass filter 104, which filters in the column direction, and the filtered output is down-sampled by two by a down-sampler 106. This provides a set of DWT coefficients for a 1HL band.

In addition to being high pass filtered in the row direction by the filter 96, the signal from unit 92 is low pass filtered in the row direction by a filter 108. The result is down-sampled by two by a down-sampler 110 and then supplied to high pass and low pass filters 112 and 114, which filter in the column direction. The output of filter 112 is down-sampled by a down-sampler 116 to provide a set of DWT coefficients for a 1LH band. The output of filter 114 is down-sampled at 118 to complete the first level of decomposition of the tile. FIG. 3C schematically illustrates the four sub-bands of DWT coefficients resulting from the first level of decomposition.

The 1LL sub-band represents low frequency information in both filtering directions at various positions. It is down-sampled by two in both directions and thus corresponds generally to a smaller-sized, lower-quality version of the image content in the original tile. The coefficient in the 1HL, 1HH, and 1LH sub-bands represent high frequency information at various positions. This high frequency information could be used at this stage to augment the low frequency information in the 1LL sub-band so as to reconstruct the image content of the original tile. However, it is quite common to continue the decomposition for one or more additional levels.

In FIG. 3B, the output of down-sampler 118 (representing the 1LL sub-band) is provided to a high pass filter 120, which filters in the row direction, and the filtered signal is down-sampled by two at 122 and then supplied to high pass and low pass filters 124 and 126, both of which filter in the column direction. The filtered results are down-sampled to provide coefficients in the 2HH and 2HL sub-bands. The output of down-sampler 118 is also low pass filtered in the row direction, down-sampled, high pass filtered in the column direction, and down-sampled to provide coefficients in a 2LH sub-band. This process of repeatedly filtering and down-sampling the low pass residue can continue. FIG. 3D illustrates sub-bands of coefficients for the second and third levels of decomposition in the region where the 1LL sub-band (see FIG. 3C) would have been had only one level of decomposition been employed.

Returning now to FIG. 3A, DWT coefficients from unit 94 are arranged in an array and quantized by quantizer 128 in accordance with quantizing values in a quantization table, the table that is selected (that is, the magnitudes of the quantizing values) depending upon the desired degree of compression in conjunction with the amount of image deterioration that can be tolerated to achieve this compression. As was the case with the DCT transform, the values in the selected table are integers which vary in magnitude depending upon the visual significance of the particular coefficients which they are to quantize. A DWT coefficient is quantized by dividing it by its quantization value from the table (some of the quantization values in the table may be numerically the same despite the fact that they are applied to different coefficients) and any remainder is discarded.

With continuing reference to FIG. 3A, quantized DWT coefficients are supplied to an entropy encoder 130 and then to a formatting unit 132, which also receives quantized-and-encoded DWT coefficients for the red and blue chrominance components from branches 88 and 90. The formatting unit 132 places the quantized-and-encoded coefficients in an encode image data frame along with various other information, including information for use in regenerating the encoded image. The frame is then supplied to an encoding image utilization unit 134 such as a storage device, a decoder, or a signal transmission unit for conveying the encoded image data frame to some desired destination.

An image decoder 136 is illustrated in FIG. 3E. It receives an encoded image data frame from a source 138. A payload extractor 140 retrieves the information for decoding the image and supplies the quantized and entropy-encoded coefficients for the luminance component to a luminance branch 142. The quantized and entropy-encoded coefficients for red and blue chrominance are supplied to chrominance branches 144 and 146. In luminance branch 142, a decoder 148 expands the entropy-encoded data so as to supply the quantized coefficients for the tiles of the luminance component to an inverse quantizer 150, which multiplies the quantized coefficients by values in a table. These values match the values by which the coefficients were divided during the quantizing procedure employed by the image encoder 80. After an inverse DWT transform by a unit 152, which regenerates pixel values for the tiles of the luminance component from the DWT coefficients, the tiles are combined into a total luminance image by a subdivision assembly unit 154. Pixel values for the combined tiles of the luminance and chrominance components are converted back to RGB space by a converter 156 and then supplied to a display apparatus 158.

### SUMMARY OF THE INVENTION

An object to the present invention is to provide a watermarking method and system that has a small error rate but that lacks the vulnerability to attack that has been needed to achieve a small error rate in the prior art.

Another object of the invention is to provide a watermarking method and system in which a range value or set of range values is compared to values generated from selected groups of coefficients on a signature-generating side, and different range values are compared to values generated from coefficients on a signature-verification side.

A further object is to provide a method and system for generating raw signature values that characterize an image file, collecting these raw signature values into sets, and then using shortened signature codes as stand-ins for the sets of raw signature values. A related object is to map the sets of raw signature values onto the shortened signature codes on the basis of the probability of occurrence of the sets of raw signature codes.

These and other objects that will become apparent during the ensuing detailed description can be attained, in accordance with one aspect of the invention, by providing a method in which groups of coefficients in a first file are selected using a predetermined selection rule; first calculated values are determined from the coefficients in each group using a predetermined calculation formula; the first calculated values are compared to at least one predetermined first range value to generate a multi-bit raw signature value for the first file; groups of coefficients in the second file are selected using the same selection rule that was employed for the first file; second calculated values are determined from the coefficients in the groups selected in the second file using the same calculation formula that was employed for the first file; the second calculated values are compared to a plurality of second range values that are different from the first range values, in order to determine acceptable raw signature values for the groups selected in the second file; and the acceptable raw signal values for the groups selected in the second file are compared with the raw signature values generated from the first file.

In accordance with another aspect of the invention, a method is provided in which groups of coefficients in a first file are selected using a predetermined selection rule; first calculated values are determined from the coefficients in each group using a predetermined calculation formula; the first calculated values are compared to at least one predetermined first range value to generate multi-bit raw signature values for the first file; the raw signature values are collected into sets of raw signature values; shortened signature codes are determined from the sets of raw signature values; groups of coefficients in the second file are selected using the same selection rule that was employed for the first file; the second calculated values are compared to a plurality of second range values to determine acceptable raw signature values for the groups selected in the second file; raw signature values are ascertained from the shortened signature codes; and the sets of raw signature values ascertained from the shortened signature codes are compared to the acceptable raw signature values.

### BRIEF DESCRIPTION OF THE DRAWINGS

FIG. 1A is a schematic diagram illustrating a conventional image encoder using discrete cosine transforms;

FIG. 1B is a schematic diagram of a conventional image decoder for regenerating the images encoded by the arrangement of FIG. 1A;

FIG. 2A illustrates an example of the selection of pairs of blocks in accordance with a prior art technique;

FIGS. 2B and 2C illustrate arrays of DCT coefficients in pairs of blocks, with an example of coefficients that are used to generate signature bits and coefficients in which the signature bids are to be embedded in accordance with the prior art technique being marked by circles and hexagons;

FIG. 2D is a graph illustrating a tolerance bound to reduce false alarms;

FIG. 3A is a schematic diagram illustrating a conventional image encoder using discrete wavelet transforms;

FIG. 3B is a schematic diagram illustrating a conventional filter and down-sampling arrangement for generating wavelet coefficients;

FIGS. 3C and 3D are diagrams illustrating decomposition of an image into sub-bands of wavelet coefficients;

FIG. 3E is a schematic diagram illustrating a conventional image decoder for regenerating an image encoded by the arrangement shown in FIG. 3A;

FIG. 4A is a schematic diagram illustrating an image encoder in an accordance with a first embodiment of the present invention;

FIG. 4B is a schematic diagram of a watermarking unit employed in FIG. 4A;

FIG. 4C illustrates an example of selection of pairs of blocks;

FIG. 4D illustrates an example of the use of different range values for coefficient differences on the signature-generation side and the signature-verification side;

FIG. 4E is a schematic diagram illustrating an image decoder in accordance with the first embodiment of the present invention;

FIG. 4F is a schematic diagram illustrating a raw signature verifier that is employed in the arrangement shown in FIG. 4E;

FIG. 4G. is a schematic diagram of another image encoder in accordance with the first embodiment;

FIG. 4H is a diagram illustrating selection of coefficient pairs in a sub and;

FIG. 4I is a schematic diagram illustrating an image decoder for images encoded by the arrangement shown in FIG. 4G;

FIG. 5A is a schematic diagram illustrating a portion of an image encoder in accordance with a second embodiment of the present invention;

FIGS. 5B and 5C are diagrams illustrating the formation of raw signature sets and the mapping of the sets onto shortened signature codes;

FIG. 5D is a schematic diagram illustrating a portion of an image decoder in accordance with the second embodiment; and

FIG. 6 illustrates mapping of raw signature sets onto shortened signature codes on the basis of the likelihood of the raw signature sets, in accordance with a third embodiment of the present invention.

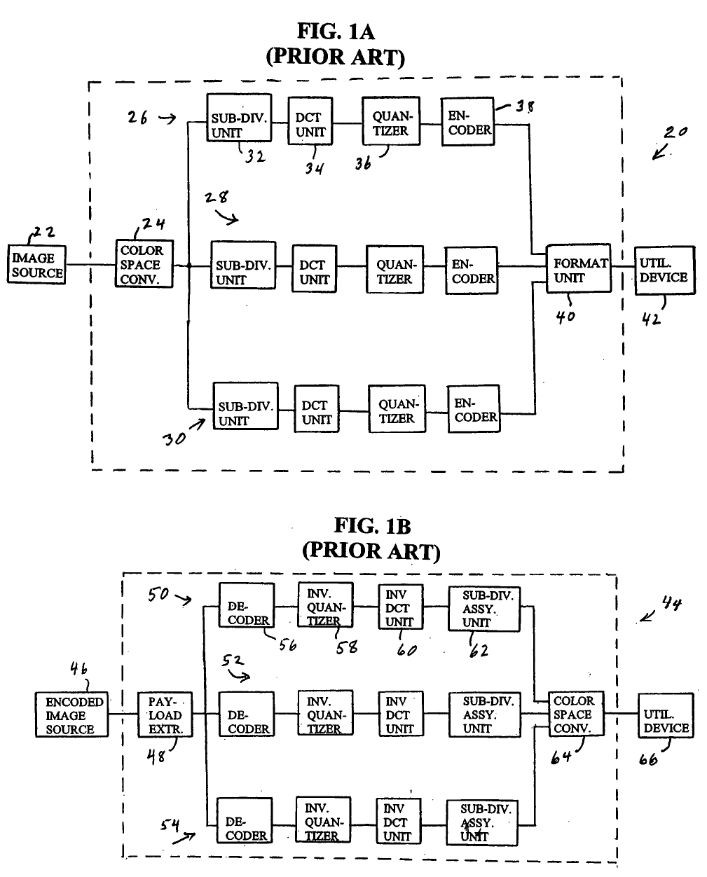

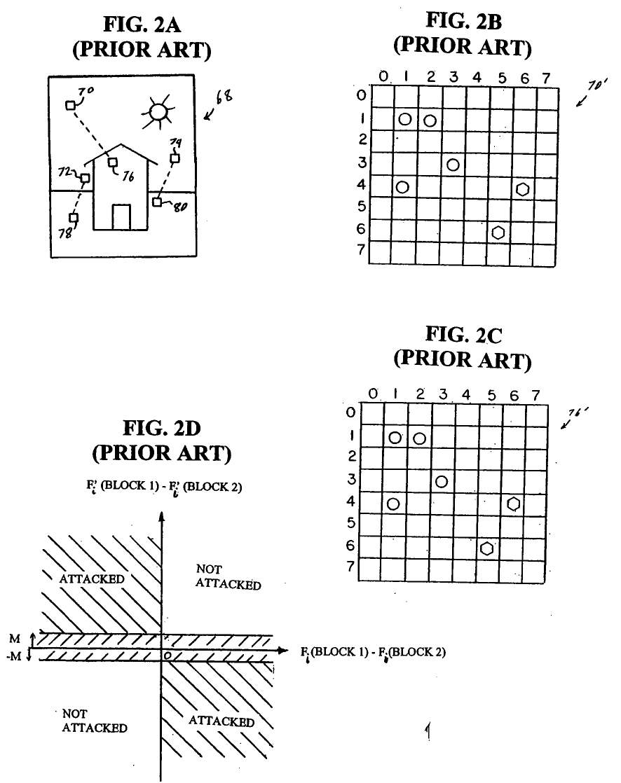

### DESCRIPTION OF THE PREFERRED EMBODIMENTS

### First Embodiment

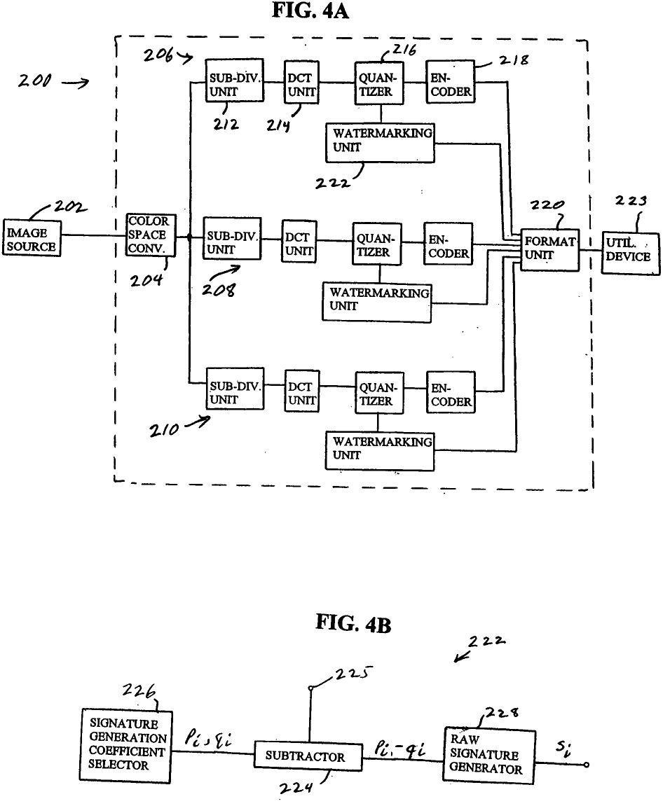

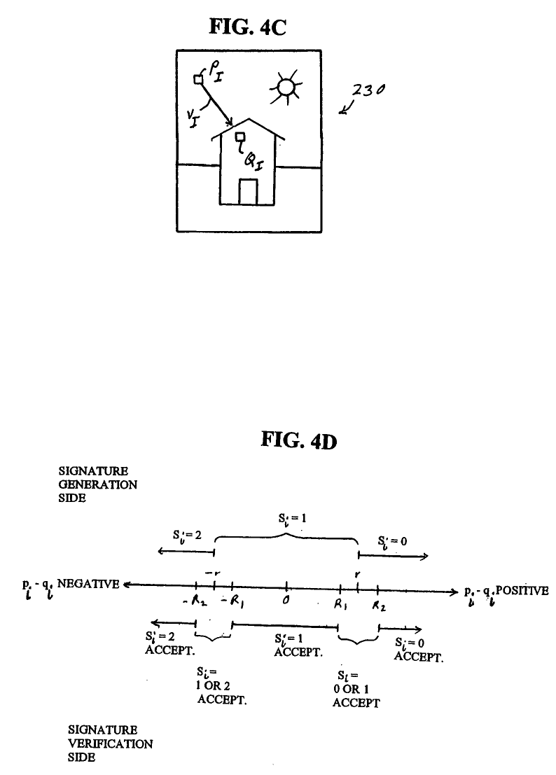

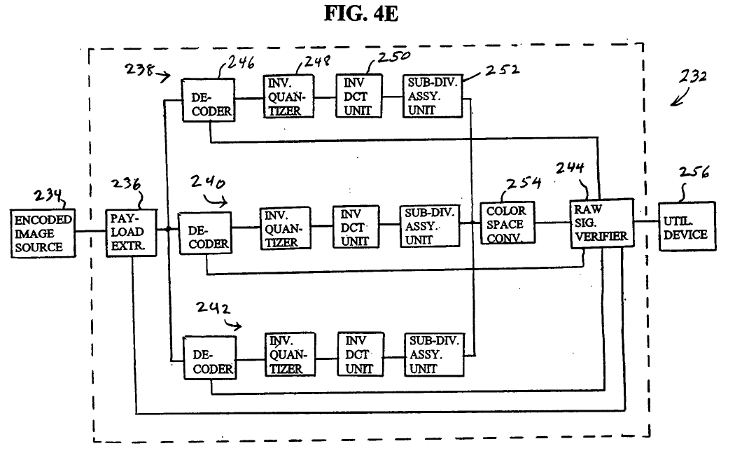

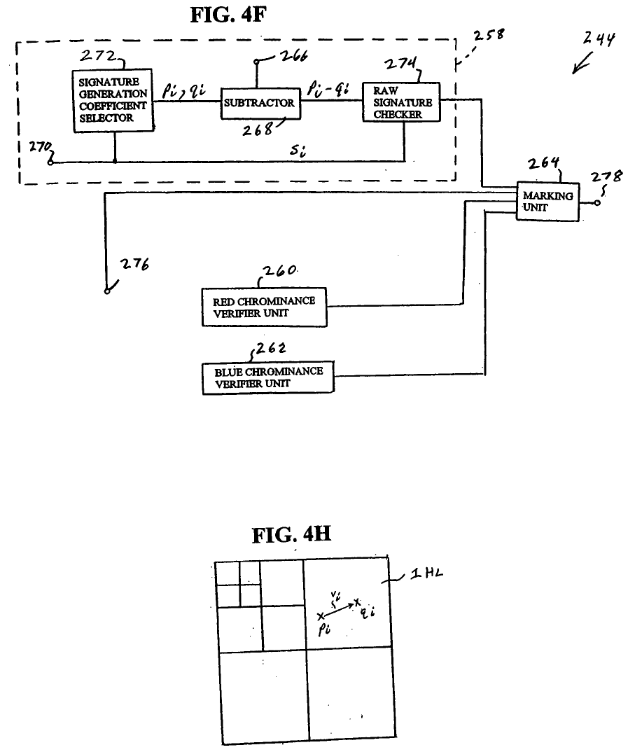

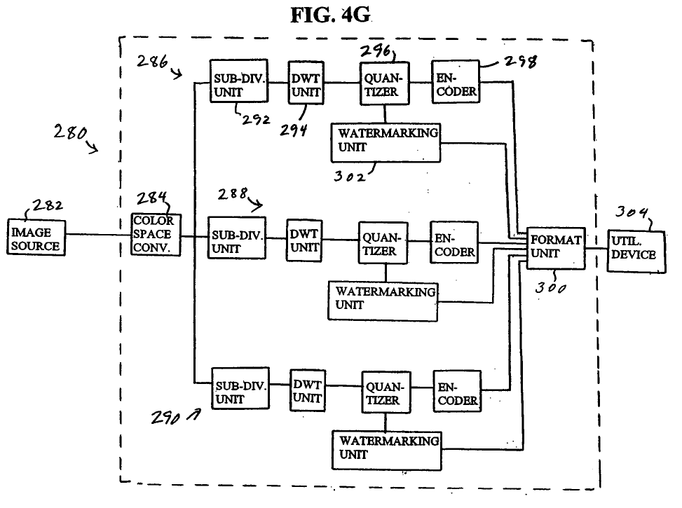

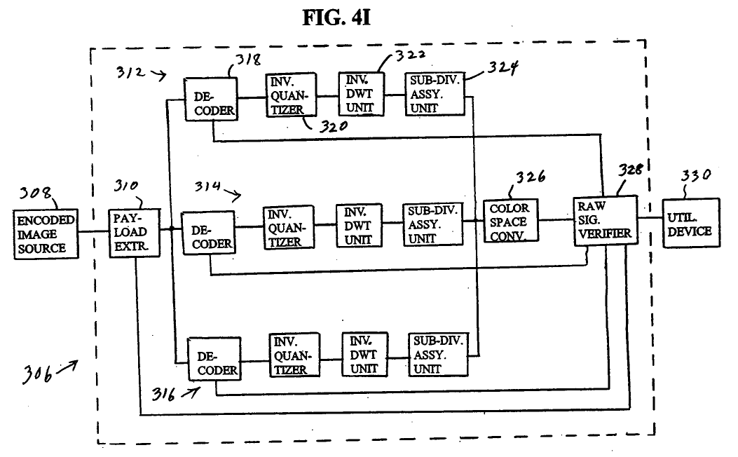

FIG. 4A illustrates an image encoder 200 in an imaging encoding system according to a first embodiment of the present intention. The encoder 200 receives a signal representing an RBG image from an image source 202, such as a digital camera, scanner, or storage device. The RGB color space is converted to an a YCrCb color space by a color space converter 204. The color space converter 204 delivers the luminance (Y) component of the image to a luminance branch 206. Similarly, the red and blue chrominance components Cr and Cb are supplied to a red chrominance branch 208 and a blue chrominance branch 210.

The luminance branch 206 includes a subdivision unit 212 that subdivides the luminance component of the image into blocks of eight-pixels by eight-pixels. These blocks are supplied to a discrete cosine transform (DCT) unit 214 that performs a discrete cosine transform on the pixel values of each block in order to generate and sixty four DCT coefficients for each block The sixty four coefficients for each block are grouped into an array and quantized by a quantizer 216 in accordance with a quantization table that is selected on the basis of the apparent image quality that is desired. The quantized coefficients are encoded by an entropy encoder 218, and then the quantized-and-encoded coefficients for each block of the luminance component are delivered to a formatting unit 220. The quantizer 216 is connected to a watermarking unit 222, which generates a set of raw signature bits Sᵢ (to be discussed later) from the quantized coefficients. The raw signature values Sᵢ are also supplied to the formatting unit 220.

The chrominance branches 208 and 210 are similar, but their quantizers use quantization tables having larger quantization values than the quantization table used in the luminance branch 206.

The formatting unit 220 forms an encoded image data frame from the quantized-and-encoded coefficients produced by the branches 206-210, and adds information in the header of the frame for use in reconstructing the image (e.g., information identifying the quantization tables and the encoding employed by the encoder 218 and the un-numbered encoders in the chrominance branches). The formatting unit 220 also places the raw signature values Sᵢ in the header. The completed image data frame is delivered to an encoded image utilization device 223 (such as a data storage device, a means for transmitting the encoded image data frame to another location, or an image decoder which regenerates the image for a display device).

FIG. 4B illustrates an example of the watermarking unit 222. It includes a subtractor 224 that receives the arrays of DCT coefficients for all of the blocks of the luminance component from the quantizer 216 via an input port 225. The subtractor 224 is also connected to a signature-generation coefficients selector 226, which identifies coefficient pairs pᵢ and qᵢ to the subtractor 224. These coefficient pairs are selected in accordance with a rule that is kept secret. The subtractor 224 subtracts the value of the coefficient qᵢ from the value of the coefficient pi and supply is an i-th difference value (pᵢ−qᵢ) resulting from the subtraction to a raw signature generator 228. The raw signature generator 228 then generates an i-th raw signature value Sᵢ, which will be discussed in more detail below.

One possibility for a rule that can be employed by the selector 226 in order to identify coefficient pairs pᵢ, qᵢ will now be discussed with reference to FIG. 4C. This Figure illustrates an image 230 of a house and the sun shining on the house. Starting blocks P₁, P₂, . . . P_{I}, . . . P_{N} are selected, preferably at various locations outward from the central region of the image, in accordance with a predetermined selection list. A random number generator is then employed to generate x and y values that define vectors V₁, V₂, . . . , V_{I}, . . . V_{N}. Vector addition of the starting blocks P_{I} and the random vectors V_{I} then yields target blocks Q_{I} that are paired with the starting blocks P_{I}. It is then necessary to employ some procedure for selecting a particular one of the sixty four DCT coefficient values generated from the pixels in the pair of blocks. One way to do this is to use i mod 64 as a selection criterion. That is, for blocks P₁ and Q₁, the first of the sixty four coefficients would be selected as the coefficients p₁ and q₁; for blocks P₂ and Q₂, the second of the sixty four coefficients would be selected as p₂ and q₂; and so on to blocks P₆₄ and Q₆₄, where the 64th coefficient would be selected from both blocks as p₆₄ and q₆₄. The next coefficient pair, p₆₄ and q₆₅, would start again with the first DCT coefficients generated for the blocks P₆₅ and Q₆₅.

The raw signature value Sᵢ produced by generator 228 is a multi-bit value that, on the signature verification side (such as an image decoder that will be described later with reference to FIG. 4E) can be used to make so-called “soft” judgments that absorb minor variations instead of permitting them to trigger possibly-false alarms. Table 2 shows one example of how this can be accomplished.

TABLE 2

| Relationship Range | Raw Signature Sᵢ |
|---|---|
| r < pᵢ-qᵢ | 0 |
| \| pᵢ-qᵢ \| ≦ r | 1 |
| pᵢ-qᵢ < −r | 2 |

In Table 2, “r” is a range value having a magnitude selected to divide the set of all possible values for the differences pᵢ−qᵢ into three regions, as shown in FIG. 4D. The range value r essentially quantizes the differences pᵢ−qᵢ into three raw signature values, Sᵢ=0, Sᵢ=1, and Sᵢ=2.

On the signature verification side, acceptable raw signature values Sᵢ are determined in accordance with Table 3:

TABLE 3

| Relationship Range | Acceptable Raw Signature Sᵢ |
|---|---|
| R₂ < pᵢ-qᵢ | 0 |
| R₁ < pᵢ-qᵢ ≦ R₂ | 0 or 1 |
| \| pᵢ-qᵢ \| ≦ R₁ | 1 |
| −R₂ ≦ pᵢ-qᵢ < −R₁ | 1 or 2 |
| pᵢ-qᵢ < −R₂ | 2 |

Two range values, R₁ and R₂, are employed in Table 3. As will be apparent from FIG. 4D, they are selected to provide reduced-tolerance gaps between regions in which only one signature value is acceptable. In each of these gaps, either of two raw signature values is acceptable, but the third raw signature value is not acceptable.

Tables 4 and 5 illustrates a further possibility. Table 4 employs two range values, r₁ and r₂, on the signature-generation side, and Table 5 uses three range values, R₁, R₂, and R₃, on the signature-verification side.

TABLE 4

| Relationship Range | Raw Signature Sᵢ |
|---|---|
| pᵢ-qᵢ > r₁ + r₂ | 0 |
| r₁ < pᵢ-qᵢ ≦ r₁ + r₂ | 1 |
| \| pᵢ-qᵢ \| ≦ r₁ | 2 |
| −r₁-r₂ ≦ pᵢ-qᵢ < −r₁ | 3 |
| pᵢ-qᵢ < −r₁ − r₂ | 4 |

TABLE 5

| Relationship Range | Acceptable Raw Signature Sᵢ |
|---|---|
| pᵢ-qᵢ ≧ R_{1 +}R₂₊R₃ | 0 |
| R₁ < pᵢ-qᵢ ≦ R₁ + R₂ | 0 or 1 |
| \| pᵢ-qᵢ \| ≦ R₁ | 0 or 1 or 2 |
| −R₁-R₂ ≦ pᵢ-qᵢ < − R₁ | 1 or 2 or 3 |
| −R₁-R₂ ≦ pᵢ-qᵢ < − R₁ | 2 or 3 or 4 |
| −R₁-R₂-R₃ ≦ pᵢ-qᵢ < − R₁ | 3 or 4 |
| pᵢ-qᵢ <− R₁-R₂-R₃ | 4 |

Turning now the FIG. 4E, an image decoder 232 for use with the encoder 200 of FIG. 4A will now be described. The decoder 232 receives an encoded image data frame from an encoded image source 234. A payload extractor 236 retrieves the encoded-and-quantized coefficients for the three components from the image data frame, and supplies them respectively to a luminance branch (Y) 238, a red chrominance branch (Cr) 240, and a blue chrominance branch (Cb) 242. The information in the header of the image data frame that is needed for decoding the components (e.g., information identifying the quantization tables employed and the entropy encoding) is also distributed to the branches 238, 240, and 242. Furthermore, the raw signature values Sᵢ that were placed in the header are conveyed to a signature verifier 244, along with information for determining the coefficient pairs pi,qi that were used by the image encoder 200.

The branch 238 includes a decoder 246 for expanding the entropy-encoded values, an inverse quantizer 248, an inverse DCT unit 250, and a subdivision assembly unit 252, which combines the blocks of the luminance component into a total luminance image. The chrominance branches 248 and 242 are similar. A color space converter 254 receives the total luminance image and the total chrominance images and converts them to the RGB color space.

The signature verifier 244 calculates difference values pᵢ−qᵢ for the selected coefficients in the block pairs P_{I} and Q_{I}, and then evaluates these difference values using the appropriate range values (e.g., those in Table 3, if Table 2 was used at the signature-generation side). If any discrepancies are detected, the relevant blocks are marked on the display device 256 that displays the reconstructed image.

FIG. 4F illustrates the construction of the signature verifier 244. It includes a luminance verifier unit to 258, a red chrominance verifier unit 260, a blue chrominance verifier unit 262, and a marking unit 264. The unit 258 has a port 266 that receives the coefficients for the luminance component from the decoder 246 (FIG. 4E) and supplies these coefficients to a subtractor 268. A port 270 receives information from payload extractor 236. This information includes the raw signature values Sᵢ generated by the image encoder, which are conveyed to a raw signature checker 272. The information received from payload extractor 236 also includes data identifying the blocks P_{I} and data identifying the random number sequence from which the vectors V_{I} were derived. This information is applied to a signature generation coefficient selector 272, which then calculates the blocks Q_{I} that are paired with the blocks P_{I} and determines the coefficient pairs pi and qi within these blocks. The coefficient pairs pᵢ, qᵢ are supplied to the subtractor 268. The subtractor 268 then uses this information identifying the pairs of coefficients and generates difference values pᵢ−qᵢ, generated on the signature-verification side, that are supplied to the raw signature checker 274. The checker 274 then determines whether the difference values pᵢ−qᵢ are compatible with the acceptable raw signatures Sᵢ in accordance with Table 3 (assuming that it was Table 2 that was used on the signature generation side). The checker 274 identifies any discrepancies to the marking unit 264.

The chrominance verifier units 260 and 262 are substantially the same as the luminance verifier unit 258. The marking unit 260 correlates the discrepancies (if any) determined by the verifier units 258-262 with the RGB image signal, which is received from the color space converter 254 (FIG. 4E) at a port to 276, and supplies a signal to the display device 256 via an output port 278. This output signal superimposes markings, which represent the discrepancies (if any) on the reconstructed image to mark regions that have been attacked.

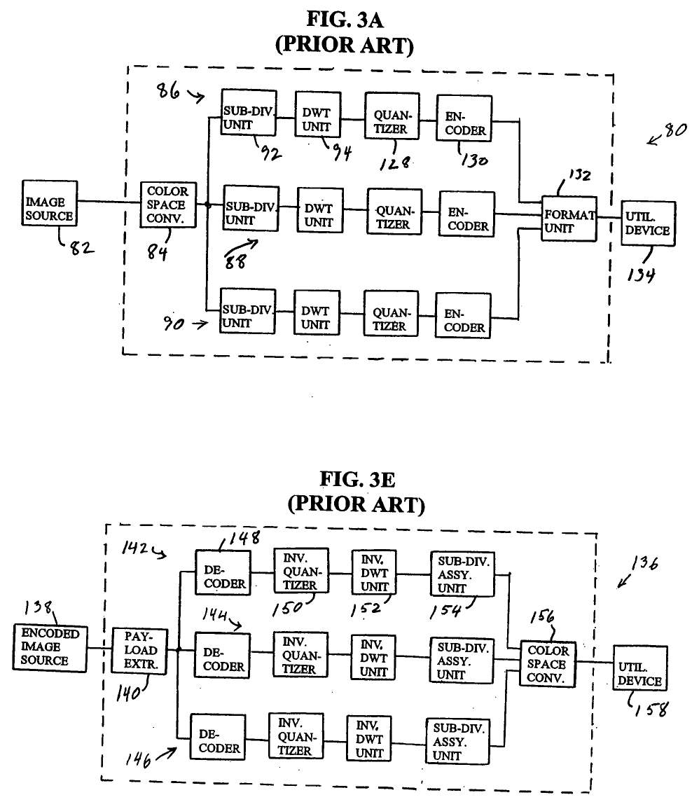

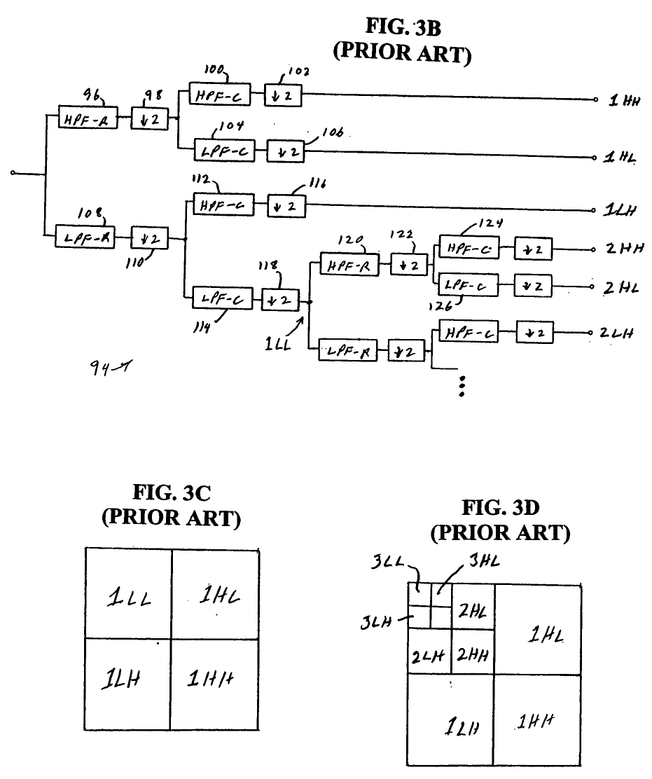

An implementation of the first embodiment that utilizes a discrete wavelet transform instead of a discrete cosine transform will now be briefly described with reference to FIGS. 4G to 4I. FIG. 4G illustrates an image encoder 280 that receives an RGB image from a source unit 282. The encoder 280 includes a converter 284 that transforms the RGB image to a YCrCb image. The luminance component is supplied to a luminance branch 286, and the red and blue chrominance components (Cr and Cb) are delivered to chrominance branches 288 and 290. The luminance branch 286 includes a subdivision unit 292 that subdivides the luminance component and provides tiles of the component to a DWT unit 272. The unit 272 performs horizontal and vertical filtration, with down-sampling, using digital filters configured to generate wavelet coefficients as previously discussed with reference to FIGS. 3A through 3E. For purposes of illustration it will be assumed that the unit 294 executes three levels of decomposition on each tile of the luminance component, and for each tile delivers wavelet coefficients for the sub-bands resulting from this three-level decomposition to a quantizer 296.

The quantizer 296 quantizes the coefficients in accordance with quantization values in a table, and supplies the quantized coefficients to an encoder 298, which entropy-encodes the coefficients for each tile of the luminance component and supplies them to a formatting unit 300. The quantizer 296 also supplies the wavelet coefficients to a watermarking unit 302. It identifies coefficients p₁, p₂, . . . , pᵢ, . . . pₙ in a given sub-band using a predetermined selection rule, generates a set of vectors v₁, v₂, . . . , vᵢ, . . . , vₙ using a random number generator, and pairs each of the coefficients pᵢ with a coefficient qᵢ by adding the vectors to the locations associated with the coefficients p₁, . . . , pₙ. An example is shown in FIG. 4H, where a coefficient pᵢ is paired with a coefficient qᵢ in the same sub-band (the 1HL sub-band in the drawing). Coefficients in one or more additional sub-bands may be paired in the same way. It should be noted that the pairing is on a sub-band by sub-band basis; coefficients are not paired with coefficients in different sub-bands.

After the watermarking unit 302 pairs the coefficients, it generates difference values pᵢ−qᵢ by subtracting each coefficient qᵢ from its paired coefficient pᵢ, generates raw signature values Sᵢ in accordance with Table 2 or Table 4, and supplies the raw signature values to the formatting unit 300. Information identifying the sub-band from which each signature value originated is also supplied to the formatting unit 300.

The chrominance branches 288 and 290 are similar, the main difference being that the quantizers in these branches employ quantization tables that, in general, resulted in larger quantization steps than in the luminance branch 286. The quantized-and-encoded coefficients, relevant information about the image (such as a file name) and about the encoder 280 (such as information identifying the quantization tables employed and entropy encoder tables), and the raw signature values Sᵢ are formatted into an encoded image data frame by the unit 300 and then delivered to an encoded image utilization device 304 (e.g., a storage device for the encoded image data frame, means for transferring it to another location, or an image decoder for restoring the image in preparation for displaying it on display device).

An image decoder 306 for decoding the image that was encoded by the image encoder 280 is shown in FIG. 4I. The encoded data image frame is supplied to the decoder 306 by a source (e.g., a storage device) 308. A payload extractor 310 supplies the quantized-and-encoded coefficients, together with information about the quantization and entropy encoding that was used to generate them, to a luminance branch 312 and to chrominance branches 314 and 316. The luminance branch includes a decoder 318 (which expands the entropy-encoded data), an inverse quantizer 320 (which multiplies the wavelet coefficients by the same quantization values that served as divisors when the original coefficients were quantized in the image encoder 280), an inverse DWT unit 322 (which generates pixel values for the tiles of the luminance component from the wavelet coefficients), and a subdivision assembly unit 324 (which stitches the tiles of the luminance component together into a total luminance image). The chrominance branches 314 and 316 are similar. The total luminance and chrominance images are supplied to a color space converter 326, which converts the YCrCb components to an RGB image.

The decoded but still-quantized wavelet coefficients from decoder 318 in the luminance branch to 288 and similar decoders in the chrominance branches are supplied to a raw signature verifier 328. The raw signature values Sᵢ (for each of the sub-bands that was used on the signature-generation side to generate them), information identifying the coefficients pᵢ that were chosen in each of the sub-bands that were used, and information about the random numbers characterizing the vectors vᵢ, are also retrieved from the header of the encoded image data frame by the payload extractor 318 and supplied to the signature verifier 328. The signature verifier 328 then computes difference values pᵢ−qᵢ in the restored image and compares them with the range values R in Table 3 (or Table 5, if Table 1 was used on the signature-generation side) to determine whether the raw signature values Sᵢ are acceptable. If not, the signature verifier 328 marks areas that are judged to have been attacked when the restored image is displayed on a device 330.

The second embodiment:

Since the first embodiment employed multi-bit raw signature values, embedding them in the coefficients themselves might alter the coefficients enough to degrade some images to an unacceptable extent. This risk was avoided, in the first embodiment, by placing the raw signature values in the header of the encoded image data frame; a separate file for storing the multi-bit raw signature values would also avoid the risk of image degradation. In the present embodiment, however, the raw signature values are shortened, so that there is less data to embed in host coefficients, in situations where it is desirable to embed the data rather than store it in the header or a separate file.

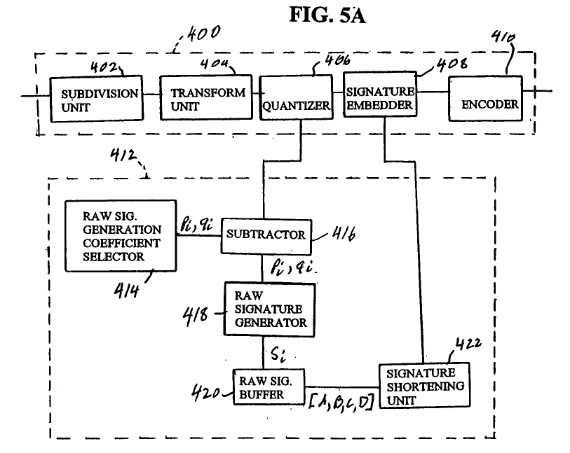

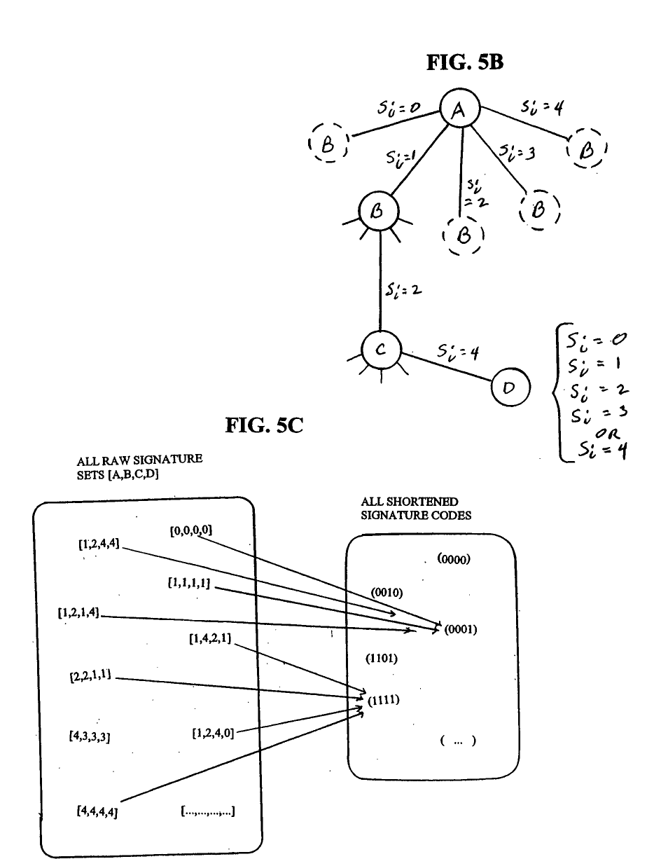

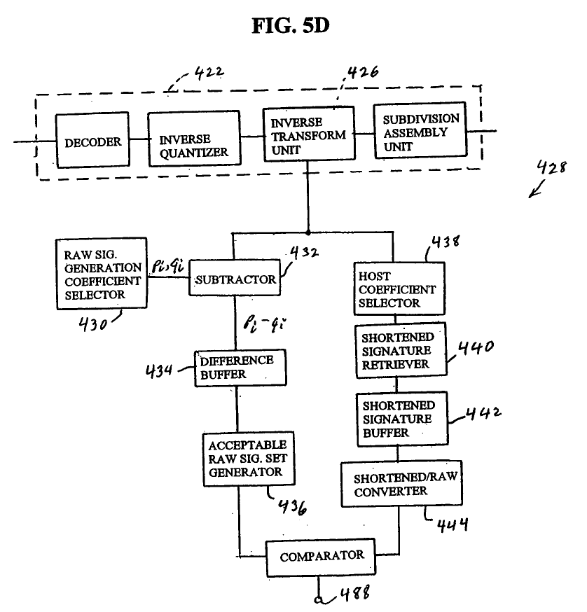

FIG. 5A illustrates a branch 400 for one component (such as the luminance component) of an image encoder. The branch includes a subdivision unit 402 which subdivides the component into smaller regions, a transform unit 404 which generates a set of coefficients characterizing each of the regions, a quantizer 406 that quantizers the coefficients in accordance with a quantization table, a signature embedder 408 (which will be discussed later), and an entropy encoder 410 for the quantized coefficients (including those with signature data embedded in them). A watermarking unit 412 is connected to the branch 400. It includes a raw signature generation coefficients selector 414, which selects source coefficients pᵢ and qᵢ in accordance with a secret selection rule (as by specifying a distribution of coefficients pi and paring them with coefficients qi using pseudo-random vectors vᵢ). A subtractor 416 receives the quantized coefficients from quantizer 406 and finds the differences pᵢ−qᵢ, and supplies the differences to a raw signature generator 418. For each of the differences pᵢ−qᵢ, the generator 418 calculates a raw signature Sᵢ in accordance with Table 4. It should be noted that the raw signatures Sᵢ in Table 4 have signature values ranging from 0 to 4.

The sequence of raw signatures Sᵢ is supplied to a raw signature buffer 420, which stores a set of four raw signatures and then supplies the set to a signature shortening unit to 422. In what follows, these four raw signatures will be called signatures A, B, C, and D, and the set of four raw signatures will be identified as [A,B,C,D].

FIG. 5B schematically illustrates the set of four raw signatures in a tree arrangement, in which the raw signature A is first, or uppermost. With two range values r₁ and r₂ on the signature-generation side, Table 4 shows five possibilities for the raw signature: Sᵢ=0, Sᵢ=1, Sᵢ=2, Sᵢ=3, and Sᵢ=4. FIG. 5B illustrates five branches from the raw signature A, one branch for each of these raw signature possibilities. In the example shown in FIG. 5B, Sᵢ=1 for the raw signature A. The next raw signature in the sequence is B, and again there are five possibilities. Sᵢ=2 is the value of raw signature B in the example shown in the figure. Next in the sequence is raw signature C where, again, there are five possibilities for the value of Sᵢ. The example in the drawing shows Sᵢ=4 for raw signature D. The next raw signature to be considered it is D. If it is assumed that Sᵢ=0 for raw signature D, then the set of four raw signatures in the example illustrated in FIG. 5B would be [1,2,4,0].

As will be appreciated from the example shown in FIG. 5B, [A,B,C,D] can have 5⁴ (that is, 625) possible values, ranging from [0,0,0,0] to [4,4,4,4]. To shorten the signatures Sᵢ, these 625 values are condensed into sixteen shortened signature codes, each represented by four bits. To condense the raw signature sets [A,B,C,D] into sixteen signature codes, approximately 40 raw signature sets are mapped onto each of the sixteen shortened signature codes. An example shown in FIG. 5C, where it will be seen that the raw signature set [1,2,4,0] that was discussed in conjunction with the example shown in FIG. 5B is one of the raw signature sets that is mapped onto the shortened signature code (1111) (for example). In FIG. 5C, the designations “[ . . . , . . . , . . . , . . . ]” and “( . . . )” are intended to indicate that many additional raw signature sets exist, and also more shortened signature codes, but they are not shown in the drawing.

Returning now to FIG. 5A, the signature shortening unit 422 receives the raw signature set [A,B,C,D] from the buffer 420 and employs a look-up table to determine the shortened signature code assigned to that raw signature set (which is “1111” in the example shown in FIG. 5C). The signature shortening unit 422 then transmits the shortened signature code to the signature embedder 408. The signature embedder 408 selects host coefficients in accordance with a rule that is kept secret and embeds the shortened signature code in the host coefficients in any desired manner. For example, four consecutive coefficients might be selected as hosts to receive the four bits of the code “1111”, with the least significant bit of each host coefficient being altered on the basis of one of the bits of the code. Another possibility, for an image encoding system employing a discrete cosine transform, would be to embed the four bits of the code into four consecutive host coefficients (or non-consecutive host coefficients, for that matter, so long as a rule is established for determining them) in accordance with the techniques taught by the article by Lin and Chang that is discussed in the “Background of the Invention” section of this document.

FIG. 5D illustrates a branch of an image decoder. The branch includes an inverse transform unit 426, which supplies coefficients (before inversely transforming them) to a signature verification unit 428. The unit 428 includes a raw signature generation coefficients selector 430 which identifies coefficient pairs pi, qi using the same selection rule that was employed by the image encoder (at the signature-generation side). A subtractor 432 receives the coefficients from the inverse transform unit 426 and subtracts those identified by the selector 430, thereby calculating difference values pᵢ−qᵢ. These difference values are supplied to a difference buffer 434, which collects a set of four consecutive difference values and supplies the set to an acceptable raw signature set generator 436. The generator 436 generates acceptable raw signature sets for the set of difference values from buffer 434, using the criteria of Table 5. An example is shown below, in Tables 6 and 7. In this example, it will be seen that acceptable raw signatures (see Table 5) for the set of four differences received from buffer 434 are the ones shown in Table 6. Then the set of all acceptable raw signature sets, for the set of differences received from buffer 434, is as shown in Table 7.

TABLE 6
Acceptable raw signatures Sᵢ for set of four
particular coefficient difference values

| | Acceptable |
|---|---|
| Pairs | raw signatures |
| pair number 1 | 1 or 2 or 3 |
| pair number 2 | 4 |
| pair number 3 | 2 or 3 or 4 |
| pair number 4 | 3 or 4 |

TABLE 7
Acceptable raw signature sets

| | | |
|---|---|---|
| [1, 4, 2, 3] | [2, 4, 2, 3] | [3, 4, 2, 3] |
| [1, 4, 3, 3] | [2, 4, 3, 3] | [3, 4, 3, 3] |
| [1, 4, 4, 3] | [2, 4, 4, 3] | [3, 4, 4, 3] |
| [1, 4, 2, .4] | [2, 4, 2, 4] | [3, 4, 2, 4] |
| [1, 4, 3, 4] | [2, 4, 3, 4] | [3, 4, 3, 4] |
| [1, 4, 4, 4] | [2, 4, 4, 4] | [3, 4, 4, 4] |

The coefficients from unit 426 (before inverse transformation) are also supplied to a host coefficients selector in 438, which identifies host coefficients in accordance with the same secret rule that was employed by the image encoder (that is, at the signature-generation side). The selector 438 passes these host coefficients to the shortened signature retriever for 440, which strips the bits of the shortened signature codes from the host coefficients and stores the stripped bits, in sets of four, in the shortened signature buffer 442. The four bits held by buffer 442 represent one of the sixteen codes for shortened signatures, and a shortened-to-raw signature converter 444 employs a look-up table to locate the approximately 40 raw signature sets [A,B,C,D] that are mapped onto the particular code held by buffer 444. This represents, essentially, the inverse of the mapping procedure illustrated in FIG. 5C.

The sets of raw signatures from converter 444 are compared to the acceptable raw signature sets from generator 436 by a comparator 446. If at least one set of raw signatures from converter 444 does not match a set of acceptable raw signatures from generator 436, the comparator 446 emits a signal via a port 448 indicating that an attack has been detected. This signal is supplied to a marking unit that superimposes information about the location of the attack on the reconstructed image.

### Third Embodiment

In the second embodiment, a relatively large number of raw signature sets are mapped onto a relatively small number of shortened signature codes. With the four-member raw signature sets [A,B,C,D] and the four bit shortened signature codes discussed above, approximately 40 raw signature sets must be mapped onto each shortened signature code. This creates a risk that an attack might not be detected if difference values pᵢ−qᵢ stemming from an attack happened to fall into the same set of acceptable raw signatures as legitimate difference values (in the absence of an attack) for the relevant coefficients.

The third embodiment reduces this risk by assigning the limited number of available shortened signature codes in such a manner that more of the shortened signature codes are allotted to the most likely sets of raw signatures, so that the ratio of raw signature sets per shortened signature code is less than 40 for the most likely sets of raw signatures. There is, of course, a corresponding increase in the ratio of raw signature sets per shortened signature code for the least likely raw signature sets.

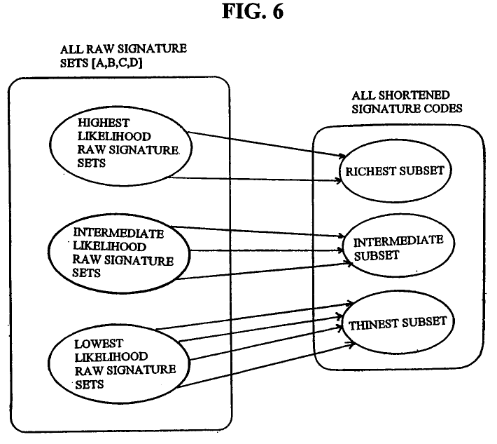

An example is illustrated in FIG. 6, where the set of all raw signature sets is divided into three separate subsets. One of them is a highest likelihood subset, another is a lowest likelihood subset, and between them lies an intermediate likelihood subset. The set of all shortened signature codes is also divided into three subsets. The sixteen available shortened signature codes (assuming that four bit codes are used) are distributed among these three subsets in such a manner that the number of raw signature sets that are mapped onto each code in the richest subset is relatively small (and it should be noted that an only the highest likelihood raw signature sets map onto the richest subset). The number of raw signature sets that are mapped onto each code in the thinnest subset of shortened signature codes is relatively large (and it should be noted that only the lowest likelihood raw signature sets map onto the thinnest subset). The set of intermediate likelihood raw signature sets is mapped onto an intermediate subset of shortened signature codes, the number of shortened signature codes in the intermediate subset being selected so that the ratio of raw signature sets per shortened signature code is smaller than for the richest subset but larger than for the thinnest subset.

Several different approaches are available for ranking the raw signature sets into different likelihood categories. One technique is to rely on Table 4, and observed that the median raw signature value is Sᵢ=2. One would therefore expect the median value of the raw signature sets [A,B,C,D] to be [2, 2, 2, 2]. One can then compute the distance X between a raw signature set and this median value as follows:
X=|A−2|+|B−2|+|C−2|+|D−2| Equation (4)

The closer the distance X is to zero for any raw signature set [A,B,C,B], the closer that raw signature set is to the median value and therefore the greater its likelihood can be considered to be. This provides a basis for establishing the likelihood subsets shown in FIG. 6. For example, all raw signature sets having a distance X smaller than 1.5 might be grouped into the highest likelihood subset, all raw signature sets having a distance X higher than 4 might be grouped into the lowest likelihood subset, and all the remaining raw signature sets might be grouped into the intermediate likelihood subset.

Variations:

It will be apparent to those skilled in the art that the specific embodiments described above are susceptible to many variations and modifications, and it is therefore the intention that such variations and modifications shall fall within the meaning and range of equivalents of the appended claims. Some of these variations and modifications will be briefly noted below.

Although the relationship between pairs of coefficients has been characterized herein by using the difference pᵢ−qᵢ, the relation can be characterized in different ways. One possibility would be to use the average, ½(pᵢ+qᵢ). Numerous other possibilities, such as the average minus the difference or the difference plus a predetermined number, also exist.

Although coefficients have been grouped into pairs in the embodiments described above, other groupings could be used. One possibility would be to use triplets of coefficients, pᵢ, qᵢ, and ri. The third coefficient rᵢ could be found, for example, by generating a second pseudo-random vector and adding it at the location associated with the coefficient pᵢ. Groups of four or more coefficients might also be employed.

Although the embodiments of encoders and decoders described herein employ DCT or DWT transforms, the invention is not limited thereto. Indeed, transforms need not be used at all, and the techniques described can be employed in the pixel domain.

Although the first embodiment employs a watermarking unit for all three branches of the image encoder and a verification unit for all three branches of the image decoder, it is believed that acceptable results can be obtained by using only one watermarking unit and one verification unit. If a single watermarking unit and a single verification unit are used, they are preferably placed in the luminance branch. The reason is that this will permit detection of attacks even if a colored image is converted to a grayscale image prior to the attacks.

Although the embodiments are described above with reference to image files, the invention is also applicable to audio-visual files and other types of files.

This application claims the benefit of priority of U.S. provisional application No. 60/302,188, filed Jun. 29, 2001, the disclosure of which is incorporated herein by reference.

1. A method for watermarking a first file which includes transform coefficients that provide information, and detecting whether a second file is an authentic version of the first file, comprising the steps of:
(a) selecting groups of coefficients in the first file using a predetermined selection rule;
(b) determining first calculated values from the coefficients in each group using a predetermined calculation formula;
(c) comparing the first calculated values to at least one predetermined first range value to generate multi-bit raw signature values for the first file;
(d) selecting groups of coefficients in the second file using the same predetermined selection rule that was employed in step (a);
(e) determining second calculated values from the coefficients in each group selected in step (d) using the same calculation formula that was employed in step (b);
(f) comparing the second calculated values to a plurality of predetermined second range values to determine acceptable raw signature values for the groups selected in step (d), the second range values being different from the at least one first range value; and
(g) comparing the acceptable raw signature values determined in step (f) to the raw signature values generated in step (c).

2. The method of claim 1, wherein the first and second files include image content.

3. The method of claim 1, wherein the transform coefficients are quantized.

4. The method of claim 1, wherein the transform coefficients are DCT coefficients.

5. The method of claim 1, wherein the transform coefficients are DWT coefficients.

6. The method of claim 1, wherein the groups of coefficients selected in steps (a) and (d) are pairs of coefficients.

7. The method of claim 6, wherein the first and second calculated values are differences between the coefficients in the pairs.

8. The method of claim 1, wherein the coefficients are coefficients for a luminance component.

9. The method of claim 1, wherein the coefficients are coefficients for a chrominance component.

10. A method for watermarking a first file which includes transform coefficients that provide image information, and detecting whether a second file is an authentic version of the first file, comprising the steps of:
(a) selecting groups of coefficients in the first file using a predetermined selection rule;
(b) determining first calculated values from the coefficients in each group using a predetermined calculation formula;
(c) comparing the first calculated values to at least one predetermined first range value to generate multi-bit raw signature values for the first file;
(d) collecting the raw signature values into sets of raw signature values;
(e) determining shortened signature codes from the sets of raw signature values;
(f) selecting groups of coefficients in the second file using the same predetermined selection rule that was employed in step (a);
(g) determining second calculated values from the coefficients in each group selected in step (f) using the same calculation formula that was employed in step (b);
(h) comparing the second calculated values to a plurality of predetermined second range values to determine acceptable raw signature values for the groups selected in step (f);
(i) ascertaining sets of raw signature values from the shortened signature codes; and
(j) comparing the sets of raw signature values ascertained in step (h) with the acceptable raw signature values determined in step (g).

11. The method of claim 10, wherein the first and second files include image content.

12. The method of claim 10, and wherein the second range values are different from the at least one first range value.

13. The method of claim 10, wherein the shortened signature codes and the raw signature values are digital data having bits, and wherein the number of bits in the sets of raw signature values is substantially larger than the number of bits in the shortened signature codes.

14. The method of claim 13, wherein the sets of raw signature values are mapped onto the shortened signature codes, the mapping being determined on the basis of the probability of occurrence of the raw signature sets.

15. The method of claim 10, wherein the groups of coefficients selected in steps (a) and (f) are pairs of coefficients.

16. The method of claim 15, wherein the first and second calculated values are differences between the coefficients in the pairs.

17. The method of claim 10, wherein the coefficients are coefficients for a luminance component.

18. The method of claim 10, wherein the coefficients are coefficients for a chrominance component.

19. A method for watermarking a first image file which includes units of image information, and detecting whether a second image file is an authentic version of the first file, comprising the steps of:
(a) selecting groups of units of image information in the first file using a predetermined selection rule;
(b) determining first calculated values from the units of image information in each group using a predetermined calculation formula;
(c) comparing the first calculated values to at least one predetermined first range value to generate multi-bit raw signature values for the first file;
(d) selecting groups of units of image information in the second file using the same predetermined selection rule that was employed in step (a);
(e) determining second calculated values from the units of image information in each group selected in step (d) using the same calculation formula that was employed in step (b);
(f) comparing the second calculated values to a plurality of predetermined second range values to determine acceptable raw signature values for the groups selected in step (d), the second range values being different from the at least one first range value; and
(g) comparing the acceptable raw signature values determined in step (f) to the raw signature values generated in step (c).
